(19) United States
(12) Patent Application Publication
(10) Pub. No.: US 2017/0364989 A1
(43) Pub. Date: Dec. 21, 2017

(54) SYSTEMS AND METHODS FOR CATEGORIZING, SEARCHING, AND RETRIEVING INFORMATION RELATING TO PRODUCTS BASED ON PROFILES

(71) Applicant: Libation Liberation, Inc., Corrales, NM (US)

(72) Inventors: Nathan Sheldon Berenson-Allan, Long Island City, NY (US); Steven Guy Sauder, Toronto (CA)

(21) Appl. No.: 15/622,561

(22) Filed: Jun. 14, 2017

Related U.S. Application Data
(60) Provisional application No. 62/350,589, filed on Jun. 15, 2016.

(51) Int. Cl. G06Q 30/06; G06F 3/0484; G06F 3/0482

(52) U.S. Cl. CPC G06Q 30/0627; G06Q 30/0641; G06F 3/0482; G06F 3/04847

(57) ABSTRACT

Disclosed embodiments provide systems and methods for categorizing, searching, and retrieving information relating to products based on flavor profiles. Embodiments allow a user to dynamically specify values for multiple parameters. Similarly, a database of products is compiled with values and/or ranges assigned for each of the multiple parameters. A user can specify preferred values for each parameter. A computer-implemented process then retrieves one or more products that have parameter values within a predetermined range of the user's specified values.

### CROSS-REFERENCE TO RELATED APPLICATIONS

The present patent document claims priority to U.S. Provisional Patent Application No. 62/350,589 filed Jun. 15, 2016, the entire contents are incorporated herein by reference.

### FIELD OF THE INVENTION

The present invention relates generally to item classification, and more particularly to systems and methods for categorizing, searching, and retrieving information relating to products based on flavor profiles.

### BACKGROUND

The number of different varieties of consumable products such as foods, beverages, and fragrance products has increased considerably in recent years. Recent studies suggest that there are over 100 different varieties of coffee, more than 2,500 varieties of beer, and over 10,000 varieties of wine. Furthermore, there are many varieties of different food types such as fruits and cheeses. Additionally, there are many different varieties of fragrance products such as perfumes and smokable products such as cigars.

Considering the example of wine alone, with over 10,000 varieties, there are many sub-categorizations of wine to select from. Wine is made from grapes, and is generally categorized based on grape types. White wines can include Riesling, Chardonnay, and Sauvignon Blanc, to name a few. Red wines can include Syrah, Merlot, Pinot Noir, and Cabernet Sauvignon, to name a few. For each wine type, there are various other attributes that affect its flavor. This can include, but is not limited to, the year of the wine, the region, and the blend. As today's consumer is presented with many possible foods, beverages, and other consumable items, it is desirable to have improvements in managing and navigating these items.

### SUMMARY

In one aspect, there is provided a computer-implemented method for selecting a sensory product, comprising: receiving a search query of a database, wherein the database comprises a plurality of records for sensory products, wherein each sensory product includes multiple attribute fields, wherein each attribute field includes a value corresponding to an attribute from the multiple attribute fields, and wherein the search query includes a value for each attribute of the multiple attribute fields; performing a comparison between one or more records within the database with the search query; identifying one or more records within the database wherein each of the multiple attribute fields of the one or more records is within a predetermined range of values from the search query; and providing a list of results including the identified one or more records.

In another aspect, there is provided an electronic device for selecting a sensory product comprising: a processor; a memory coupled to the processor, the memory containing instructions, that when executed by the processor, perform the steps of: receiving a search query of a database, wherein the database comprises a plurality of records for sensory products, wherein each sensory product includes multiple attribute fields, wherein each attribute field includes a value corresponding to an attribute from the multiple attribute fields, and wherein the search query includes a value for each attribute of the multiple attribute fields; obtaining a comparison result between one or more records within the database based on the search query; identifying one or more records within the database wherein each of the multiple attribute fields of the one or more records is within a predetermined range of values from the search query; and providing a list of results including the identified one or more records.

In yet another aspect, there is provided a computer program product for selecting a sensory product using an electronic computing device, the electronic computing device comprising a computer readable storage medium having program instructions embodied therewith, the program instructions executable by a processor to cause the electronic computing device to: receive a search query of a database, wherein the database comprises a plurality of records for sensory products, wherein each sensory product includes multiple attribute fields, wherein each attribute field includes a value corresponding to an attribute from the multiple attribute fields, and wherein the search query includes a value for each attribute of the multiple attribute fields; perform a comparison between one or more records within the database with the search query; identify one or more records within the database wherein each of the multiple attribute fields of the one or more records is within a predetermined range of values from the search query; and provide a list of results including the identified one or more records.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

FIG. 1 is an environment for embodiments of the present invention.

FIG. 2 is a block diagram of a device in accordance with embodiments of the present invention.

FIG. 3A is an exemplary user interface for wine selection.

FIG. 3B shows exemplary data for wine selection.

FIG. 4A is an exemplary search results user interface.

FIG. 4B is an exemplary graphical parameter match comparison.

FIG. 5 is an exemplary user interface for beer selection.

FIG. 6 is an exemplary user interface for cheese selection.

FIG. 7 is an exemplary user interface for cigar selection.

FIG. 8 is an exemplary user interface for perfume selection.

FIG. 9 is a flowchart indicating process steps for embodiments of the present invention.

### DETAILED DESCRIPTION

Disclosed embodiments provide systems and methods for categorizing, searching, and retrieving information relating to products based on flavor profiles. Embodiments allow a user to dynamically specify values for multiple parameters. Similarly, a database of products is compiled with values and/or ranges assigned for each of the multiple parameters. A user can specify preferred values for each parameter. A computer-implemented process then retrieves one or more products that have parameter values within a predetermined range of the user's specified values.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Moreover, the described features, structures, or characteristics of the invention may be combined in any suitable manner in one or more embodiments. Aspects described with respect to one embodiment may be combined with other embodiments. Features of the embodiments may be “mixed and matched” in any suitable way. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, integers, steps, operations, elements, components, and/or groups thereof.

In embodiments, a software as a service (SaaS) is provided. In such an embodiment, a service provider provides a computer infrastructure operable to perform embodiments of the invention. A customer (an establishment), such as a restaurant or liquor store then subscribes to a service from a service provider. The service provider compiles an inventory database of customer inventory. For example, each restaurant and liquor store can have its own inventory database that is managed by the service provider. The values may be input by a person with administrative privileges from the customer, imported from another database or file, or input by the service provider. A user, upon entering the venue, is then able to use a computing device such as a tablet computer to dynamically input preferred values for various attributes. As an example pertaining to wine, acidity can be one such attribute. Tannins can be another such attribute pertaining to wine. The user dynamically selects preferred values for each attribute. The inventory database is then searched and one or more results are provided to the user. Thus, disclosed embodiments allow a user to quickly ascertain which wines in the restaurant's inventory may be of liking to the user. Other features and aspects of disclosed embodiments are further described herein.

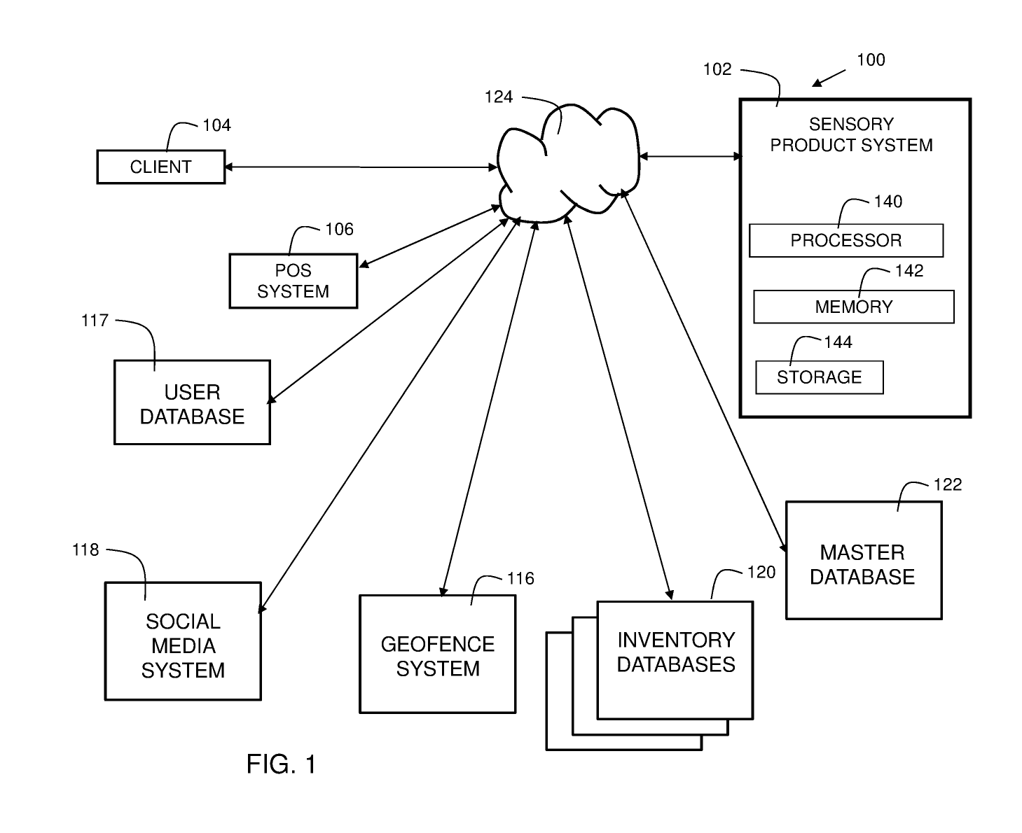

FIG. 1 is an environment 100 for embodiments of the present invention. Environment 100 includes sensory product system 102 which includes a processor 140, a memory 142, and storage 144. The storage 144 may include one or more hard disk drives, solid state drives, or the like. The memory 142 contains instructions, that when executed by the processor, may perform one or more steps in accordance with some embodiments of the present invention. In embodiments, the memory 142 may include a flash, static RAM, ROM, or other suitable memory type. In some embodiments, the memory 142 may be non-transitory. The sensory product system 102 is connected to network 124. In embodiments, network 124 may include the Internet or other suitable network.

The system 102 may communicate with multiple additional systems and/or databases. In embodiments, the communication between system 102 and the multiple additional systems and/or databases may occur via network 124. System 102 may communicate with a user database 117. Each user may optionally establish a profile within user database 117. The profile can include a unique identifier such as a username, along with preferred values for each of the multiple attributes. The profile can further include multiple instances of preferred values, where each instance may be labeled to signify a particular situation. For example, a user can establish a “steakhouse” instance that includes preferred values for a wine to have with steak, whereas a “seafood” instance can include preferred values for a wine to have with seafood.

A user, upon entering an establishment such as a restaurant, may perform a login process using a client device such as client 104. Client 104 is an electronic device. In embodiments, the client device may be a tablet computer provided by the restaurant. In other embodiments, the client device may be the user's own mobile device using an app and/or mobile web page to perform the login process. In some embodiments, the login process may be skipped, and the user can interact with the system as a guest, without logging in. Thus, embodiments can include establishing a profile for a user, wherein the profile includes preference values for the multiple attribute fields. Additionally, embodiments may include accepting a user login attempt, and loading user preference values for each attribute of the multiple attribute fields in response to a successful user login attempt.

In some embodiments, the user login process may associate the user with a corresponding login on a social media system 118. Thus, system 102 may communicate with social media system 118. In such an embodiment, when a user selects a product for purchase via the client 104, a notification and/or post is generated on social media system 118. In this way, selected products can be promoted via social media.

System 102 communicates with a master database 122. The master database 122 may be maintained by a service provider. The master database 122 may be a comprehensive product catalog of products from a variety of manufacturers. The master database 122 may include values for multiple parameters for each product within the master database 122. In some cases, the values used for a particular parameter may be subjective. In other cases, the values are based on algorithmic data based on scientific measurements and/or tools that are used to calculate the value. Measured (objective) examples pertaining to wine include alcohol (ABV), Residual Sugar, and pH (a measure of acidity or alkalinity).

System 102 communicates with one or more inventory databases 120. The inventory databases 120 are a subset of records from the master database 122. For example, different restaurants have different inventories, and therefore, each restaurant may have its own inventory database which includes a subset of the records in the master database 122. In embodiments, the service provider performs an inventory of the establishment to determine which database records from the master database 122 should be included in a particular inventory database 120. In a situation where an establishment carries a product that is not currently in the master database 122, it can be added to the master database 122. In some embodiments, one or more inventory databases may be stored on, or mirrored to the client device 104. This enables operation of embodiments in an offline mode where the device does not have network connectivity. In such embodiments, a user is still able to browse the list of inventory items and find potential products for selection, even without connectivity to networked databases.

In some embodiments, the master database 122 can include a food database, a beverage database, a fragrance database, and/or a smokable product database. When the master database 122 includes a beverage database, the database may include a wine database, a beer database, and/or a coffee database.

System 102 may communicate with a geofence system 116. In such an embodiment, the geofence system may establish geographical boundaries where a particular product is available. In such an embodiment, a user may establish a “wish list” of beverages he/she wishes to try, a list of favorite beverages, and/or one or more instances of preferred values of multiple attributes. When a user, with his/her mobile device travels within the limits of the geofence established by geofence system 116, the user may receive a push notification indicating the availability of a product. For example, the push notification may recite: “Joe's Tavern 800 feet ahead carries Chateau Margaux 2009 Balthazar.” In this way, users can be notified about opportunities to try products that are on a wish list. In other embodiments, the push notification may be based on the user's preferred values for attributes. For example, if the user likes beverages with a particular combination of attributes, and an establishment within the geofence has one or more products that are a good match for the user preferences, the user may receive a push notification accordingly. For example, the push notification may recite: “Joe's Tavern 800 feet ahead carries 37 products that match your preferences.” In this way, the user is notified regarding nearby establishments that carry products that the user may like.

System 102 may communicate with a point-of-sale (POS) system 106. In such an embodiment, the user may select a product for purchase, and the purchase order is sent to POS system 106 by the system 102. One such use case for this is tableside ordering. For example, in a restaurant, a server may enter a table number into client 104 device before handing the client device (e.g. tablet computer) to a guest. The guest then orders items (e.g. drinks) via the tablet by placing them into a virtual cart or other suitable e-commerce method. Then the items are sent to the POS system 106 and the server can then obtain the information about the ordered products and deliver them to the table corresponding to the previously entered table number.

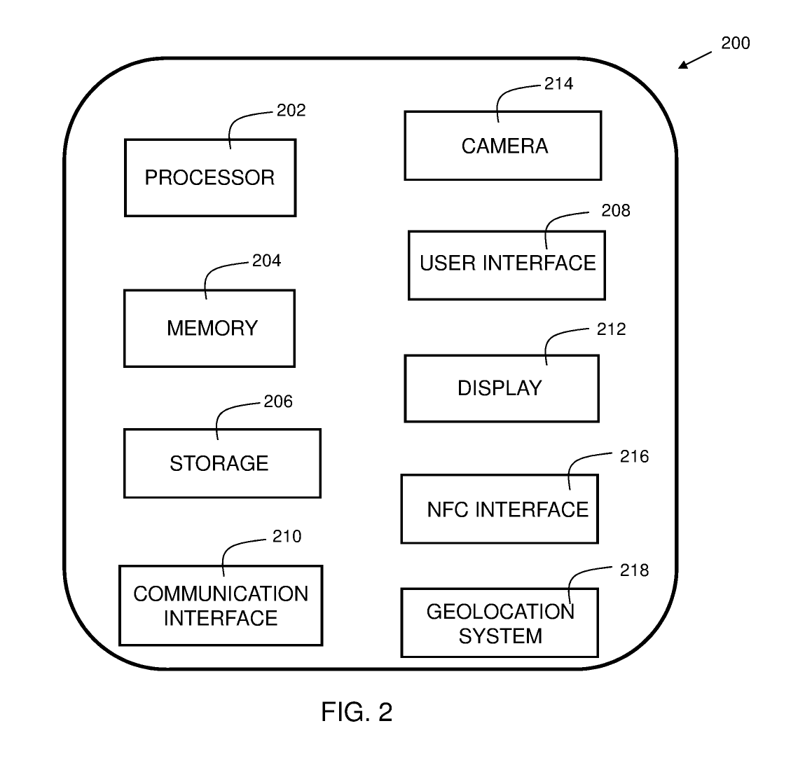

FIG. 2 is a block diagram of a device 200 in accordance with embodiments of the present invention. Device 200 is shown as a simplified diagram of modules. Device 200 is an electronic computing device. Device 200 includes a processor 202, which is coupled to a memory 204. Memory 204 may include dynamic random access memory (DRAM), static random access memory (SRAM), magnetic storage, and/or a read only memory such as flash, EEPROM, optical storage, or other suitable memory. In some embodiments, the memory 204 may be non-transitory memory. Memory 204 includes instructions, which when executed by the processor, implement steps of the present invention. In embodiments, device 200 may have multiple processors 202, and/or multiple cores per processor.

Device 200 may further include storage 206. In embodiments, storage 206 may include one or more magnetic storage devices such as hard disk drives (HDDs). Storage 206 may include one or more solid state drives (SSDs). Any other suitable storage device may be included instead of, or in addition to, those disclosed herein.

Device 200 may further include a user interface 208, examples of which include a keyboard, mouse, and/or a touch screen, incorporating a capacitive or resistive touch screen in some embodiments.

The device 200 includes a communication interface 210. In embodiments, the communication interface 210 may include a wireless communication interface that includes modulators, demodulators, and antennas for a variety of wireless protocols including, but not limited to, Bluetooth™ Wi-Fi, and/or cellular communication protocols for communication over a computer network. Any other suitable communication interface, now known or hereafter developed, may be substituted.

The device 200 further includes a display 212. Display 212 may be a liquid crystal display (LCD), a plasma display, a cathode ray tube (CRT) display, a light emitting diode (LED) display, an organic LED (OLED) display, or other suitable display technology. The display 212 may include a touch screen.

The device 200 may optionally include a camera 214. The camera may be used to acquire an image of a barcode, QR code, text, and/or image of a product of interest. In embodiments, one or more inventory databases may be searched for the product associated with the acquired image. An example use case is that of a user at a friend's house and finds a bottle of wine that he/she likes. The user uses the camera to acquire an image of the label of the wine, including a barcode. The product corresponding to that barcode is retrieved from the master database. In embodiments, the user may have the option to add that product to his/her favorites and/or wish list. Additionally, one or more inventory databases may be searched. If the product exists in any of the searched inventory databases, the user can be notified about which establishments (e.g. restaurants and/or liquor stores) carry the product.

In some embodiments, the device 200 may further include near field communication (NFC) interface 216. The NFC interface may include protocols such as Bluetooth, Zigbee, and/or other suitable protocols. In embodiments, the NFC interface may be used to perform an automatic login process. An example use case is that of a user entering a liquor store and approaching a kiosk. The device 200 may be a user's mobile device. The user may be automatically logged in to the kiosk based on the proximity of the NFC interface 216 to the kiosk. The kiosk may be a client device such as indicated at 104 in FIG. 1. When the user is automatically logged in, the user's preferences for values of the multiple attributes are loaded in, so that relevant product choices can be more quickly and conveniently presented to the user.

In some embodiments, the device 200 may further include a geolocation system 218. The geolocation system 218 can include Global Positioning System (GPS), GLONASS, or other suitable geolocation system. The geolocation system can be used to support embodiments that utilize geofences for identification of nearby establishments that carry products matching criteria established by the user via preference values for multiple parameters.

In some embodiments, the device 200 may be a device carried/owned by a user.

In other embodiments, the device 200 may be a kiosk, tablet computer, or other device located at an establishment to allow users to search the establishment's inventory based on user preferences.

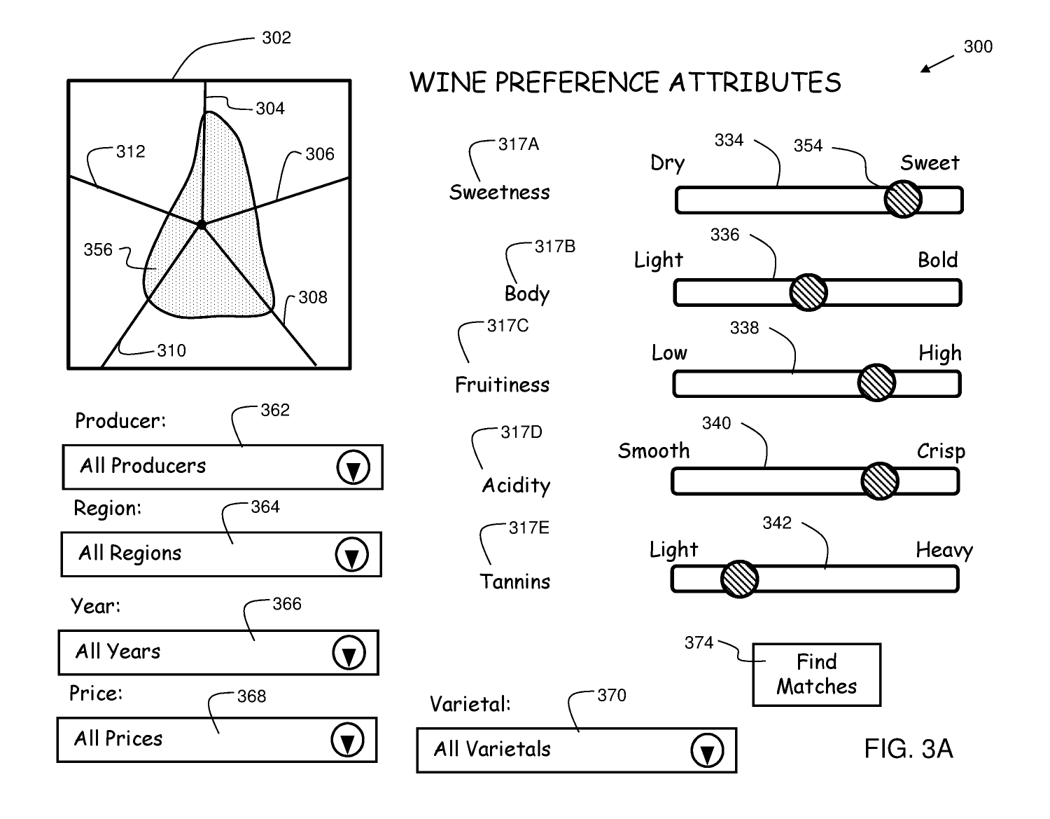

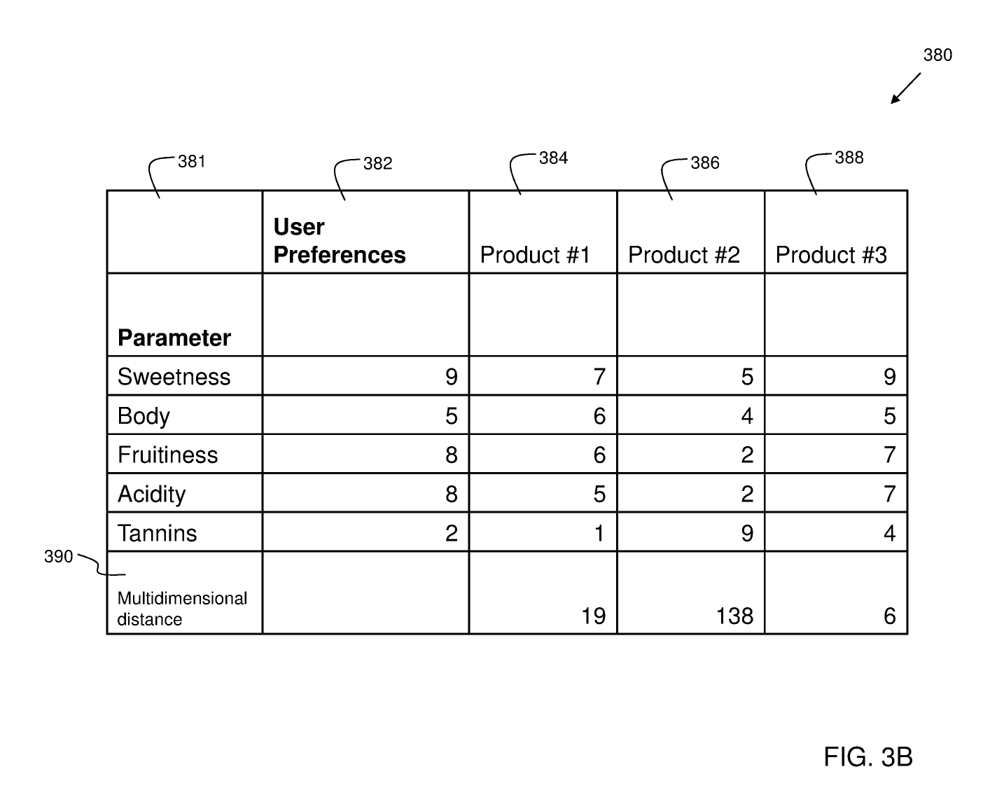

FIG. 3A is an exemplary user interface 300 for wine selection. Five parameters (attribute fields) are shown in user interface 300. Parameter 317A is Sweetness. Parameter 317B is Body. Parameter 317C is Fruitiness. Parameter 317D is Acidity. Parameter 317E is Tannins. Other parameters may be used instead of, or in addition to, the examples 317A-317E. Thus, in embodiments, the multiple attribute fields can include attribute fields of sweetness, body, fruitiness, acidity, and tannins

For each parameter, a corresponding dynamic control is used to allow the user to select a preferred value for that parameter. As shown in user interface 300, the dynamic controls are implemented as slider controls. However, other dynamic controls such as knobs, numeric entry fields, buttons, or other suitable dynamic controls may be used. In embodiments, the dynamic controls are rendered electronically on a touch screen electronic display, such as that of a tablet computer. Thus, in embodiments, a value for each attribute of the multiple attribute fields is dynamically selectable. Embodiments may further include providing a dynamically selectable value slider control for each attribute of the multiple attribute fields.

Slider control 334 selects the value for parameter 317A based on the location of knob 354 within slider control 334. In this case, the parameter is Sweetness, and the user moves the location of knob 354 between a low value described as “Dry” and a high value described as “Sweet.”

Slider control 336 selects the value for parameter 317B based on the location of its knob within slider control 336. In this case, the parameter is Body, and the user moves the location of the corresponding knob between a low value described as “Light” and a high value described as “Bold.”

Slider control 338 selects the value for parameter 317C based on the location of its knob within slider control 338. In this case, the parameter is Fruitiness, and the user moves the location of the corresponding knob between a low value described as “Low” and a high value described as “High.”

Slider control 340 selects the value for parameter 317D based on the location of its knob within slider control 340. In this case, the parameter is Acidity, and the user moves the location of the corresponding knob between a low value described as “Smooth” and a high value described as “Crisp.”

Slider control 342 selects the value for parameter 317E based on the location of its knob within slider control 342. In this case, the parameter is Tannins, and the user moves the location of the corresponding knob between a low value described as “Light” and a high value described as “Heavy.”

As the user dynamically adjusts the slider controls corresponding to parameters 317A-317E, a corresponding flavor graph 302 is dynamically updated. The flavor graph 302 comprises multiple axes, each axis representing one of the multiple parameters. In flavor graph 302, axis 304 corresponds to parameter 317A of Sweetness, axis 306 corresponds to parameter 317E of Body, axis 308 corresponds to parameter 317C of Fruitiness, axis 310 corresponds to parameter 317D of Acidity, and axis 312 corresponds to parameter 317E of Tannins. The closed shape 356 is rendered based on the preferred values of the multiple parameters as established via the slider controls. As the user adjusts the sliders, the closed shape 356 changes to reflect the values set by the user. Thus, embodiments include a graphical representation of current values of the multiple attribute fields as a closed shape. In embodiments, there may be more or fewer axes on graph 302. The axes may correspond to parameters different than those shown in the example herein.

User interface 300 further includes a plurality of filters 362-370 that can be used to further narrow the search. In some embodiments, each filter is implemented as a dropdown list box that allows the user to make a selection based on the filter category. In some embodiments, the filters may be implemented using other mechanisms, such as radio buttons, check boxes, slider controls, or other suitable input. Filter 362 allows the user to filter by producer. Filter 364 allows the user to filter by regions. Filter 366 allows the user to filter by year. Filter 368 allows the user to filter by price. Filter 370 allows the user to filter by varietal or style (e.g. Kosher or Organic). Once the slider controls and filters are set to the user's preferences, the user can invoke button 374 to find matches. In some embodiments, more or fewer filters may be included.

In embodiments, the user interface 300 is implemented on a client device (e.g. 104 of FIG. 1). When the user invokes button 374, the values based on the slider control settings and the filter configuration is sent to the sensory product system 102. The sensory product system then performs a search of one or more inventory databases 120 and/or master database 122 to find matches. In embodiments, matches may be determined by computing a multidimensional distance from the user preference values. In embodiments, the multidimensional distance D for a given product P may be computed as:

$$D = {\sum }_{i = 1}^{T} {( {U}_{i} - {P}_{i} )}^{2}$$

Where:

T is the total number of parameters;

i is the index for a given parameter;

Ui is a parameter value set by the user for index i; and

Pi is a parameter value set in the master database for the product P for index i.

In some embodiments, each parameter may have a value ranging from zero to ten.

In other embodiments, other ranges may be used (e.g. zero to 100, etc . . . ).

Referring now to FIG. 3B showing data table 380, it shows user preference values as follows:

Sweetness: 9

Body: 5

Fruitiness: 8

Acidity: 8

Tannins: 2

These values are shown in column 382 of FIG. 3B. Data for three exemplary products are also shown in data table 380, indicated as product 190 1, product #2, and product #3. The values for the parameters indicated in column 381 are shown for each product. The values for product #1 are shown in column 384. The values for product #2 are shown in column 386. The values for product #3 are shown in column 388. The multidimensional distance for each product is shown in row 390, computed by the previously described formula. A lower multidimensional distance indicates a closer match to the user determined values in column 382. As is shown in data table 380, the multidimensional distance for product #1 is 19, the multidimensional distance for product #2 is 138, and the multidimensional distance for product #3 is 6. Thus, in the example data of data table 380, product #3 is the closest match to the user preference values indicated in column 382. In some embodiments, predetermined threshold levels may be established to indicate multiple levels of matching. As an example, a multidimensional distance of ten or less may be indicated to the user as a “perfect match.” Similarly, a multidimensional distance ranging between 11 and 20 may be indicated to the user as a “great match.” Given these thresholds and the example data of data table 380, product #3 is indicated to the user as a “perfect match” and product ·1 is indicated to the user as a “great match.” Thus, a “great match” does not match as closely as a “perfect match” but is sufficiently close to the user preference values set in column 382 that it may be a product that the user would enjoy. Product #2 has the largest multidimensional distance of the three products, and may not be a good fit for the user based on the user preference values set in column 382. Thus, product #2 would not be presented to the user as a potential match, as it is outside the predetermined threshold range of 20. In some embodiments, percentage value thresholds may be used instead of, or in addition to, a multidimensional distance, along with adjectives to provide an indication of matching.

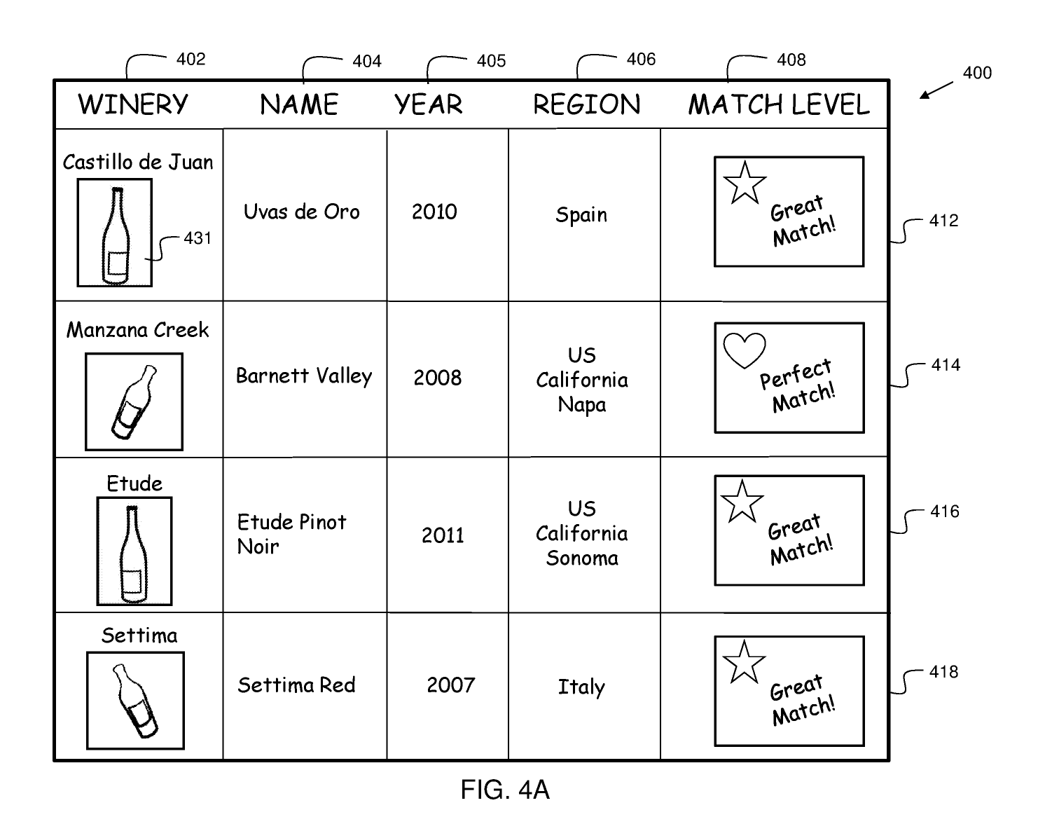

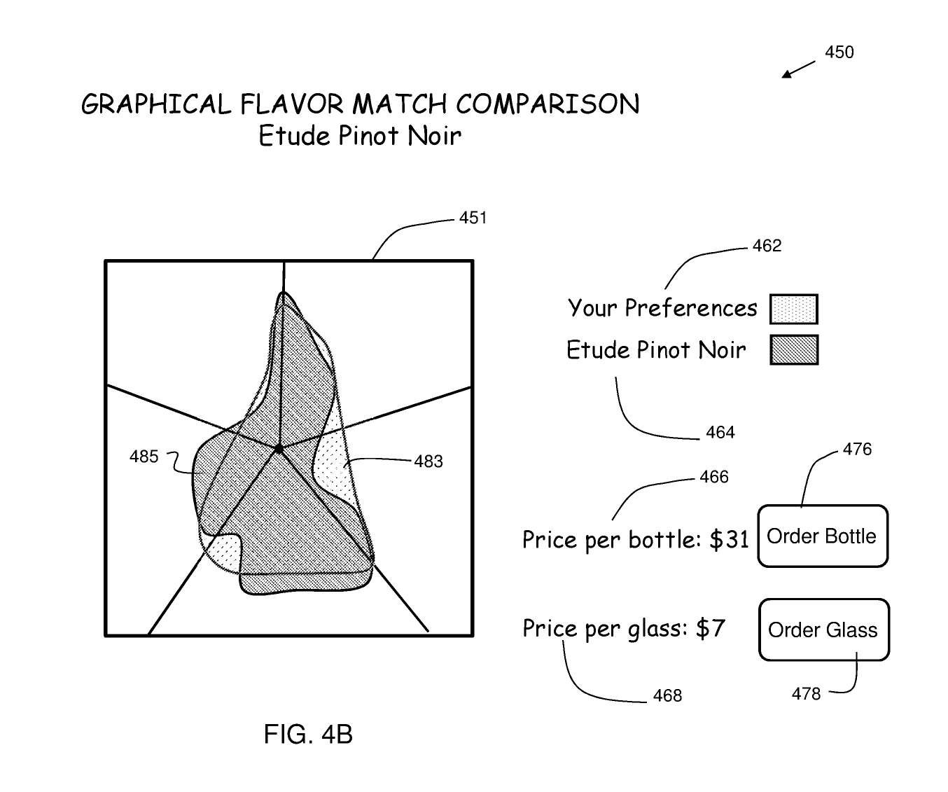

FIG. 4A is an exemplary search results user interface 400. Column 402 indicates a winery. Column 404 indicates a name of the wine. Column 405 indicates the year of the wine. Column 406 indicates the region of the wine. Column 408 indicates the match level for the wine. Each row (412, 414, 416, and 418) corresponds to a product retrieved by the search. In embodiments, a product image, indicated generally as 431 may be included in each product listing. Products listed in rows 412, 416, and 418 are indicated as a great match as indicated by data in the match level column 408. The product listed in row 414 is indicated as a perfect match as indicated by the match level column 408. While two match levels are illustrated in FIG. 4A, other embodiments may have more or fewer match levels.

Additional information may also be provided, including, but not limited to, price per bottle, and price per glass (if applicable). Additionally, an option to order a bottle/glass of the wine may be provided in the form of a button, or by simply selecting the corresponding entry by touching, clicking, or otherwise selecting it.

The aforementioned description describes an embodiment geared towards wine selection. However, disclosed embodiments can be adapted to work with a wide variety of products, including, but not limited to, coffee, beer, whiskey, and other beverages. Additionally, disclosed embodiments can work with foods such as fruits, cheeses, breads, pastas, candy, cereal, and the like. Additionally, disclosed embodiments can work with smokable products such as cigarettes, cigars, and other smokable products. Additionally, disclosed embodiments can work with fragrance products such as perfume, cologne, air fresheners, and the like. Thus, embodiments can include receiving a search query of a database, wherein the database comprises a plurality of records for sensory products, wherein each sensory product includes multiple attribute fields, and wherein each attribute field includes a value corresponding to an attribute from the multiple attribute fields, wherein the search query includes a value for each attribute of the multiple attribute fields, obtaining a comparison result between one or more records within the database based on the search query, and identifying one or more records within the database wherein each of the multiple attribute fields of the one or more records is within a predetermined range of values from the search query, and providing a list of results including the identified one or more records.

FIG. 4B is an exemplary graphical parameter match comparison 450. In this example, the graphical parameter match comparison is a graphical flavor match comparison. For example, when the user selects the product in row 416 of FIG. 4A, they may be presented with the comparison 450. A graphical display 451 shows a first shape 483 corresponding to user preferences. A second shape 485 corresponds to the values of the product. A legend 462 indicates the pattern used for the graph of the user preferences, and a legend 464 indicates the pattern used for the graph of the product that is being compared with the user preferences. This allows a user to visually see how his/her flavor preference aligns with a particular item. The comparison 450 may further include pricing information for a bottle and glass (if applicable). Bottle price field 466 indicates a price for a bottle of the product. Glass price field 468 indicates a price for a glass of the product. This information may be retrieved from an inventory database. Thus, in some embodiments, each database record further comprises a bottle price field and a glass price field. Some embodiments may further include a button 476 to allow a user to order a bottle of the wine while sitting at a table. Similarly, some embodiments may further include a button 478 to allow a user to order a glass of the wine while sitting at a table.

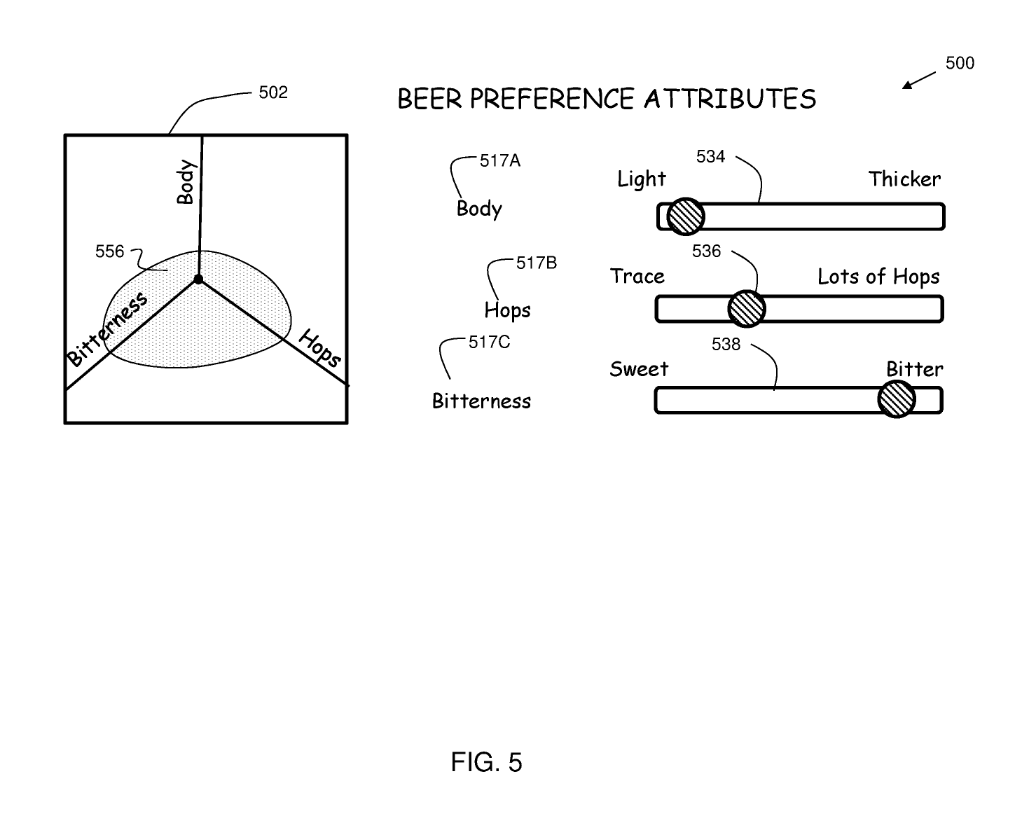

FIG. 5 is an exemplary user interface 500 for beer selection. The operation is similar to that of the user interface 300 of FIG. 3A for wine selection. In this embodiment, there are fewer attributes than in the embodiment shown in FIG. 4. The attributes 517A-517C are pertinent for beer instead of wine. Note that embodiments may have more or fewer attributes displayed than those depicted in the illustrated examples.

Slider control 534 selects the value for parameter 517 A based on the location of its knob within slider control 534. In this case, the parameter is Body, and the user moves the location of the corresponding knob between a low value described as “Light” and a high value described as “Thicker.”

Slider control 536 selects the value for parameter 517B based on the location of its knob within slider control 536. In this case, the parameter is Hops, and the user moves the location of the corresponding knob between a low value described as “Trace” and a high value described as “Lots of Hops.”

Slider control 538 selects the value for parameter 517C based on the location of its knob within slider control 538. In this case, the parameter is Bitterness, and the user moves the location of the corresponding knob between a low value described as “Sweet” and a high value described as “Bitter.”

As the user dynamically adjusts the slider controls corresponding to parameters 517A-517C, a corresponding closed shape 556 in flavor graph 502 is dynamically updated. Similar to as described for wine, a multidimensional distance for various beers is computed and presented to the user as search results.

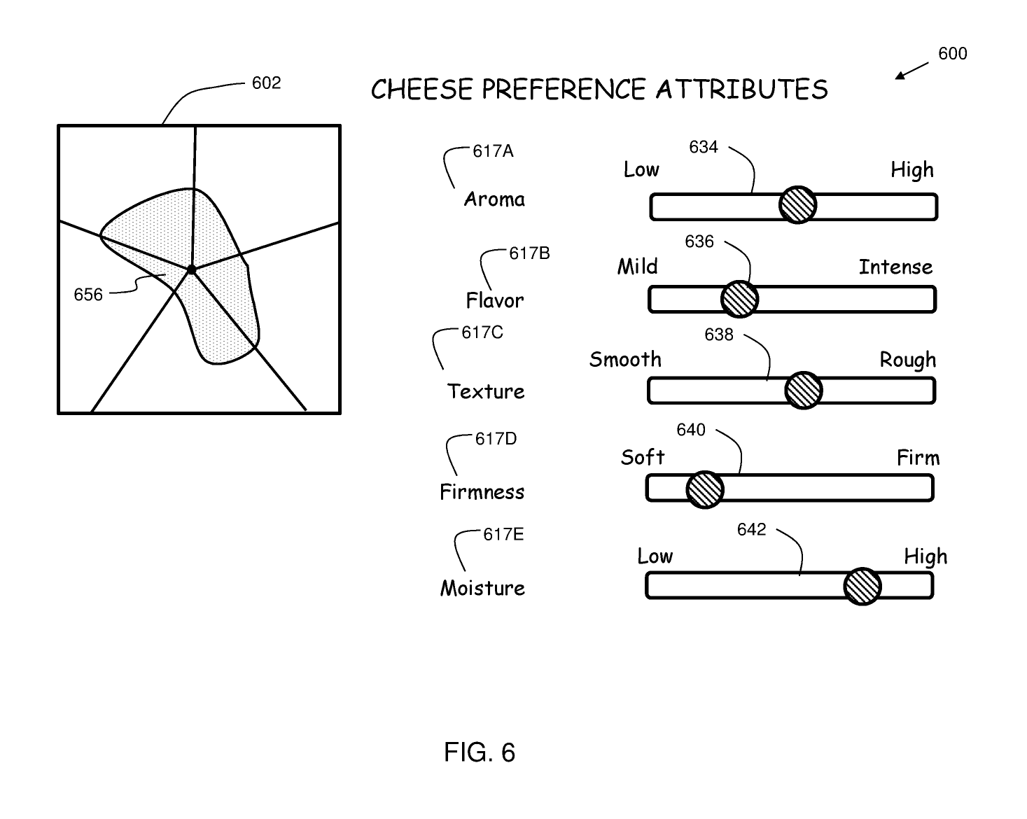

FIG. 6 is an exemplary user interface 600 for food selection. In this example, the food is cheese. The operation is similar to that of the user interface 300 of FIG. 3A for wine selection. However, the attributes 617A-617E are pertinent for cheese instead of wine.

Slider control 634 selects the value for parameter 617A based on the location of its knob within slider control 634. In this case, the parameter is Aroma, and the user moves the location of the corresponding knob between a low value described as “Low” and a high value described as “High.”

Slider control 636 selects the value for parameter 617B based on the location of its knob within slider control 636. In this case, the parameter is Flavor, and the user moves the location of the corresponding knob between a low value described as “Mild” and a high value described as “Intense.”

Slider control 638 selects the value for parameter 617C based on the location of its knob within slider control 638. In this case, the parameter is Texture, and the user moves the location of the corresponding knob between a low value described as “Smooth” and a high value described as “Rough.”

Slider control 640 selects the value for parameter 617D based on the location of its knob within slider control 640. In this case, the parameter is Firmness, and the user moves the location of the corresponding knob between a low value described as “Soft” and a high value described as “Firm.”

Slider control 642 selects the value for parameter 617E based on the location of its knob within slider control 642. In this case, the parameter is Moisture, and the user moves the location of the corresponding knob between a low value described as “Low” and a high value described as “High.”

As the user dynamically adjusts the slider controls corresponding to parameters 617A-617E, a corresponding closed shape 656 in flavor graph 602 is dynamically updated. Similar to as described for wine, a multidimensional distance for various cheeses is computed and presented to the user as search results.

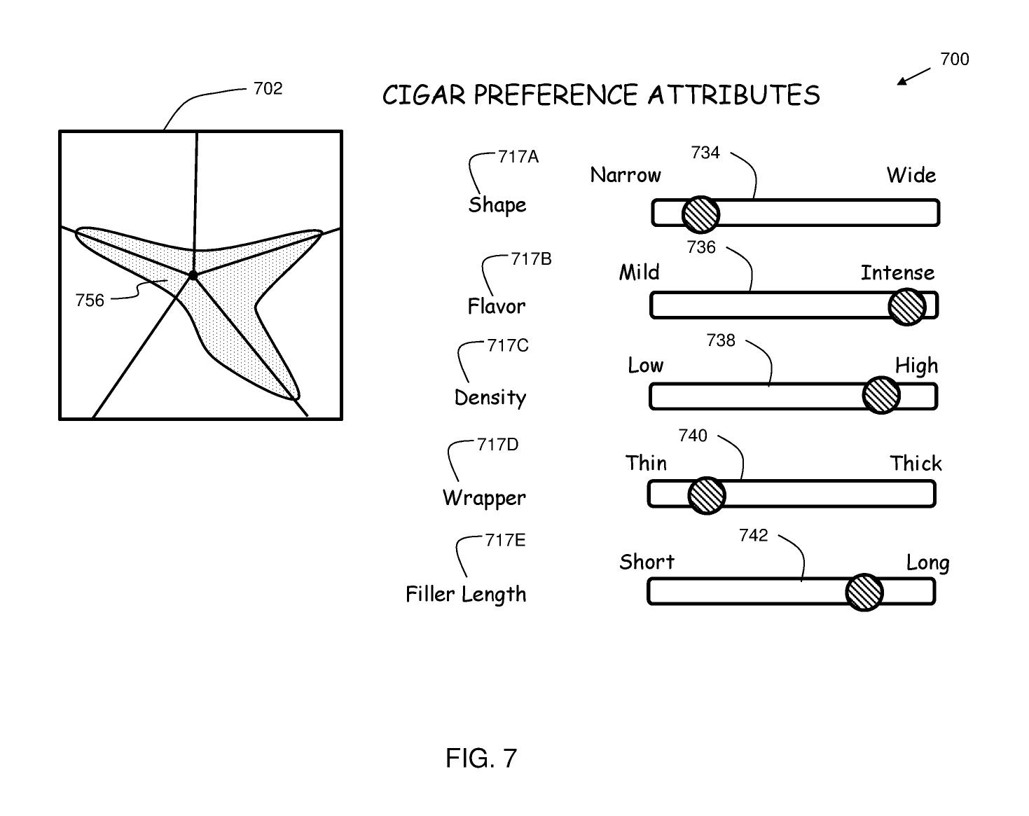

FIG. 7 is an exemplary user interface 700 for a smokable product selection. In this example, the smokable product is cigars. The operation is similar to that of the user interface 300 of FIG. 3A for wine selection. However, the attributes 717A-717E are pertinent for cigars instead of wine.

Slider control 734 selects the value for parameter 717A based on the location of its knob within slider control 734. In this case, the parameter is Shape, and the user moves the location of the corresponding knob between a low value described as “Narrow” and a high value described as “Wide.”

Slider control 736 selects the value for parameter 717B based on the location of its knob within slider control 736. In this case, the parameter is Flavor, and the user moves the location of the corresponding knob between a low value described as “Mild” and a high value described as “Intense.”

Slider control 738 selects the value for parameter 717C based on the location of its knob within slider control 738. In this case, the parameter is Density, and the user moves the location of the corresponding knob between a low value described as “Low” and a high value described as “High.”

Slider control 740 selects the value for parameter 717D based on the location of its knob within slider control 740. In this case, the parameter is Wrapper, and the user moves the location of the corresponding knob between a low value described as “Thin” and a high value described as “Thick.”

Slider control 742 selects the value for parameter 717E based on the location of its knob within slider control 742. In this case, the parameter is Filler Length, and the user moves the location of the corresponding knob between a low value described as “Short” and a high value described as “Long.”

As the user dynamically adjusts the slider controls corresponding to parameters 717A-717E, a corresponding closed shape 756 in flavor graph 702 is dynamically updated. Similar to as described for wine, a multidimensional distance for various cigars is computed and presented to the user as search results.

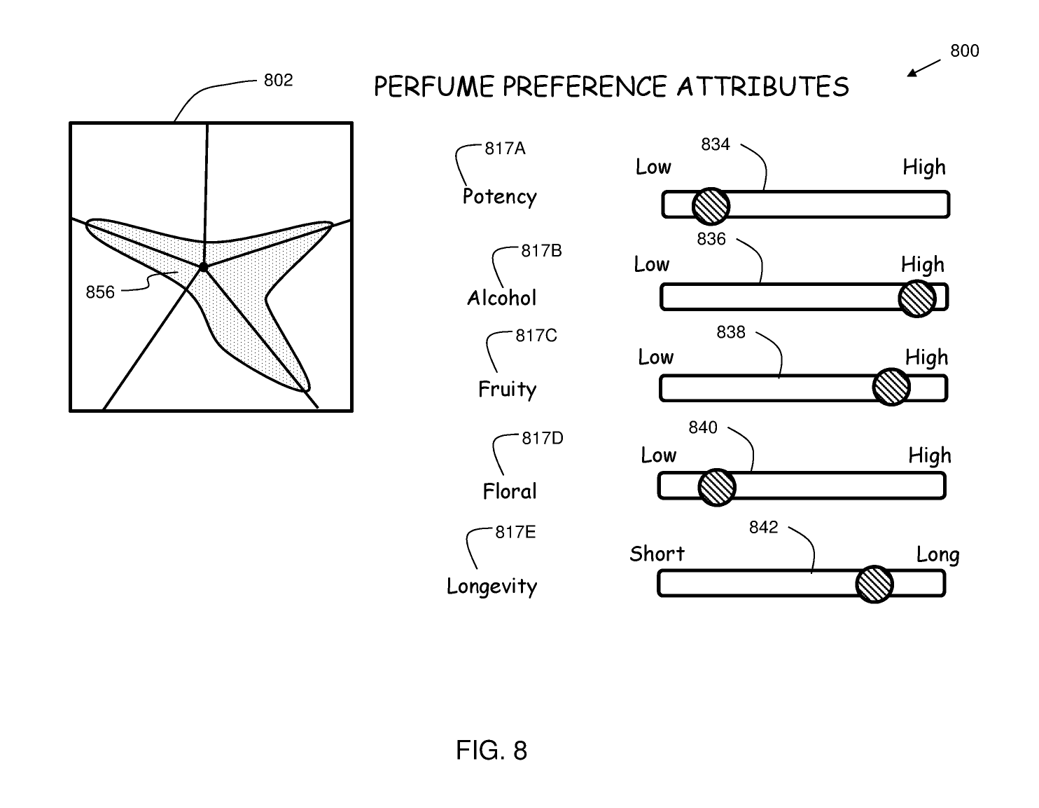

FIG. 8 is an exemplary user interface 800 for fragrance selection. In this example, the fragrance product is perfume. The operation is similar to that of the user interface 300 of FIG. 3A for wine selection. However, the attributes 817A-817E are pertinent for perfume instead of wine.

Slider control 834 selects the value for parameter 817A based on the location of its knob within slider control 834. In this case, the parameter is Potency, and the user moves the location of the corresponding knob between a low value described as “Low” and a high value described as “High.”

Slider control 836 selects the value for parameter 817B based on the location of its knob within slider control 836. In this case, the parameter is Alcohol, and the user moves the location of the corresponding knob between a low value described as “Low” and a high value described as “High.”

Slider control 838 selects the value for parameter 817C based on the location of its knob within slider control 838. In this case, the parameter is Fruity, and the user moves the location of the corresponding knob between a low value described as “Low” and a high value described as “High.”

Slider control 840 selects the value for parameter 817D based on the location of its knob within slider control 840. In this case, the parameter is Floral, and the user moves the location of the corresponding knob between a low value described as “Low” and a high value described as “High.”

Slider control 842 selects the value for parameter 817E based on the location of its knob within slider control 842. In this case, the parameter is Longevity, and the user moves the location of the corresponding knob between a low value described as “Short” and a high value described as “Long.”

As the user dynamically adjusts the slider controls corresponding to parameters 817A- 817E, a corresponding closed shape 856 in flavor graph 802 is dynamically updated. Similar to as described for wine, a multidimensional distance for various perfumes is computed and presented to the user as search results.

The aforementioned examples are exemplary. Other parameters may be used instead of, or in addition to, those parameters shown in the previously described figures.

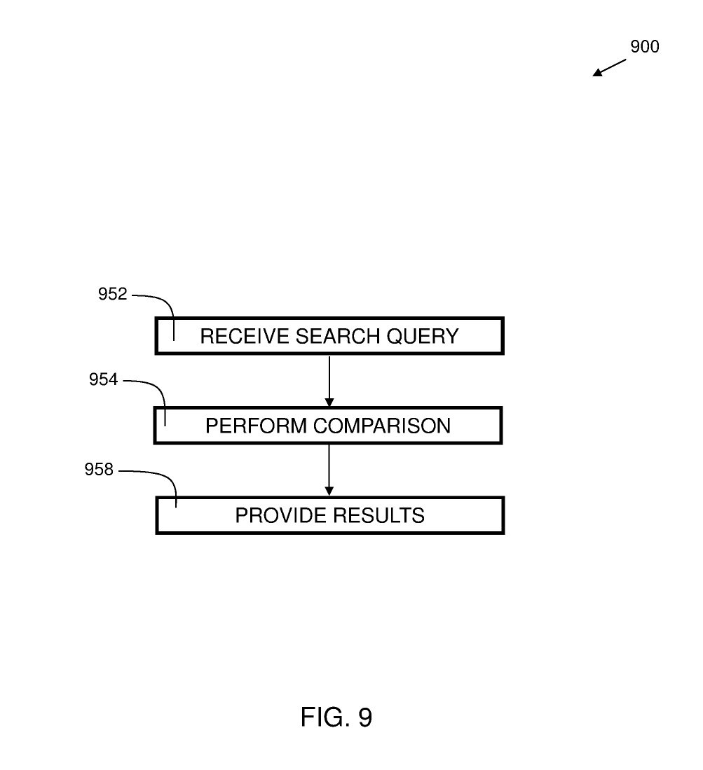

FIG. 9 is a flowchart 900 indicating process steps for embodiments of the present invention. In process step 952 a search query is received from a database. The database can be a master database and/or one or more inventory databases. The search query can include one or more user-established values for multiple parameters, and may further include additional filtering options as shown in FIG. 3A. In process step 954 a comparison between values specified by the user and those for the products is performed. In embodiments, the comparison can include performing a multidimensional distance computation. In process step 958, results are provided to the user. The results may be provided in a list format and may include images of the products. Multiple levels of matching may be provided to the user.

As can now be appreciated, disclosed embodiments provide systems and methods for categorizing, searching, and retrieving information relating to products based on flavor profiles. Embodiments allow a user to dynamically specify values for multiple parameters. Similarly, a database of products is compiled with values and/or ranges assigned for each of the multiple parameters. A user can specify preferred values for each parameter. A computer-implemented process then retrieves one or more products that have parameter values within a predetermined range of the user's specified values. This allows users to easily and quickly navigate the myriad of choices for products such as wine, beer, cheese, etc. Furthermore, disclosed embodiments can interface with geofencing and/or social media systems to provide enhanced customer experience and improved marketing. Additionally, analytics may be collected such as number of selections as compared with number of purchases for a given product. This can be valuable for manufacturers to understand if an adjustment to product description or price is warranted in order to improve sales. Another advantage is the ability to perform product inventory alerts. When it is detected that a particular product is at a low quantity level in the inventory database, an alert can be sent to owners of the establishment. For example, if there are less than ten bottles of a particular wine remaining, then an alert can be sent to the owner/manager of the establishment so that the item can be reordered.

Another key advantage of disclosed embodiments is that the computer-implemented selection process can be updated and edited at any time. This means that when an establishment runs out of inventory on a given product, or adds a product, there is no need to print all new paper menus, or even alert staff that you are out of a product and to try not to sell it, resulting in a poor guest experience. Thus, disclosed embodiments provide a comprehensive solution for managing and searching through large lists of consumable products.

Also noted above, some embodiments may be embodied in software. The software may be referenced as a software element. In general, a software element may refer to any software structures arranged to perform certain operations. In one embodiment, for example, the software elements may include program instructions and/or data adapted for execution by a hardware element, such as a processor. Program instructions may include an organized list of commands comprising words, values, or symbols arranged in a predetermined syntax that, when executed, may cause a processor to perform a corresponding set of operations.

Some of the embodiments may be embodied in hardware. The hardware may be referenced as a hardware element. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor devices, chips, microchips, chip sets, and so forth. However, the embodiments are not limited in this context.

Embodiments of the present invention may also include a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), ROM), a digital versatile disk (DVD), a memory stick, a floppy disk, a mechanically encoded device such as punch cards or raised structures in a groove having instructions recorded thereon, and any suitable combination of the foregoing. A computer readable storage medium, as used herein, may be non-transitory, and thus is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Program data may also be received via the network adapter or network interface.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the disclosure outlines exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with embodiments of the present invention. Furthermore, the methods according to embodiments of the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of embodiments of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of embodiments of the invention.

What is claimed is:

1. A computer-implemented method for selecting a sensory product, comprising:
receiving a search query of a database, wherein the database comprises a plurality of records for sensory products, wherein multiple attribute fields in the records correspond to each sensory product, wherein each attribute field includes a value corresponding to an attribute from the multiple attribute fields, and wherein the search query includes a value for each attribute of the multiple attribute fields;
performing a comparison between one or more records within the database with the search query;
identifying one or more records within the database wherein each of the multiple attribute fields of the one or more records is within a predetermined range of values from the search query; and
providing a list of results including the identified one or more records.

2. The method of claim 1, the database comprises a beverage database.

3. The method of claim 1, wherein the database comprises a food product database.

4. The method of claim 1, wherein the database comprises a fragrance database.

5. The method of claim 1, wherein the database comprises a smokable product database.

6. The method of claim 2, wherein the beverage database includes a wine database.

7. The method of claim 2, wherein the beverage database includes a beer database.

8. The method of claim 2, wherein the beverage database includes a coffee database.

9. The method of claim 6, wherein the multiple attribute fields include attribute fields of:
sweetness;
body;
fruitiness;
acidity; and
tannins.

10. The method of claim 1, wherein the value for each attribute of the multiple attribute fields is dynamically selectable.

11. The method of claim 10, further comprising providing a dynamically selectable value slider control for each attribute of the multiple attribute fields.

12. The method of claim 6, wherein each database record further comprises a bottle price field and a glass price field.

13. The method of claim 1, further comprising establishing a profile for a user, wherein the profile includes preference values for the multiple attribute fields.

14. The method of claim 1, further comprising displaying a graphical representation of current values of the multiple attribute fields as a closed shape.

15. An electronic device for selecting a sensory product comprising:
a processor;
a memory coupled to the processor, the memory containing instructions, that when executed by the processor, perform the steps of:
receiving a search query of a database, wherein the database comprises a plurality of records for sensory products, wherein each sensory product includes multiple attribute fields, wherein each attribute field includes a value corresponding to an attribute from the multiple attribute fields, and wherein the search query includes a value for each attribute of the multiple attribute fields;
obtaining a comparison result between one or more records within the database based on the search query;
identifying one or more records within the database wherein each of the multiple attribute fields of the one or more records is within a predetermined range of values from the search query; and
providing a list of results including the identified one or more records.

16. The electronic device of claim 15, wherein the memory further contains instructions, that when executed by the processor, perform the step of displaying values for multiple attribute fields including:
sweetness;
body;
fruitiness;
acidity; and
tannins.

17. The electronic device of claim 15, wherein the memory further contains instructions, that when executed by the processor, perform the step of providing a dynamically selectable control for each attribute of the multiple attribute fields.

18. The electronic device of claim 17, wherein the memory further contains instructions, that when executed by the processor, perform the step of providing a slider control for the dynamically selectable controls.

19. The electronic device of claim 17, wherein the memory further contains instructions, that when executed by the processor, perform the step of displaying a graphical representation of current values of the multiple attribute fields as a closed shape.

20. A computer program product for selecting a sensory product using an electronic computing device, the electronic computing device comprising a computer readable storage medium having program instructions embodied therewith, the program instructions executable by a processor to cause the electronic computing device to:
receive a search query of a database, wherein the database comprises a plurality of records for sensory products, wherein each sensory product includes multiple attribute fields, wherein each attribute field includes a value corresponding to an attribute from the multiple attribute fields, and wherein the search query includes a value for each attribute of the multiple attribute fields;
perform a comparison between one or more records within the database with the search query;
identify one or more records within the database wherein each of the multiple attribute fields of the one or more records is within a predetermined range of values from the search query; and
provide a list of results including the identified one or more records.
